(19) United States
(12) Patent Application Publication
(10) Pub. No.: US 2002/0097274 A1
(43) Pub. Date: Jul. 25, 2002

(54) Graphical user interface

(76) Inventor: Andrew Philip Morgan, Oxford (GB)

Correspondence Address: ARENT FOX KINTNER PLOTKIN & KAHN, PLLC, Suite 600, 1050 Connecticut Avenue, N.W., Washigton, DC, 20036-5339, US

(21) Appl. No.: 09/767,229

(22) Filed: Jan. 23, 2001

(51) Int. Cl. G06F 3/14

(52) U.S. Cl. 345/810; 345/854

(57) ABSTRACT

A computer system comprising processing means and a display, the processing means being arranged in use to implement a Microsoft Windows™ operating system under which a management window can be displayed on said display such that it can be navigated using a web browser. The management window has a first frame containing a web style page and a second frame displaying one or more systems which can be controlled by the user, wherein upon selection of one of the systems by the user the current page displayed in said first frame is replaced by a page specific to the selected system.

### FIELD OF THE INVENTION

The present invention relates to a graphical user interface and more particularly to a graphical user interface of a Microsoft Windows™ operating system.

### BACKGROUND TO THE INVENTION

The Microsoft Windows™ series of computer operating systems present a graphical user interface which the vast majority of computer users are familiar with. Windows™ 95 (OSR 2.1), 98, 2000, and Millennium have advanced the ease of use of the operating system by introducing computer control operation windows which have the look and feel of Internet Explorer™ pages. These windows are referred to as “web views”. One example of a web view can be seen in the Printers Folder, which can be accessed via the “Start” button from the desktop taskbar, selecting in sequence “Settings”, and “Printers”.

FIG. 1 illustrates the web view for Windows 2000™, from which it can be seen that the information display window is split into two frames. The right hand frame contains conventional file items comprising an “Add Printer” icon and icons representing installed printer devices. When no icon in the right hand frame is selected, the left hand frame contains general information relating to use of the printer folder. When one of the printer device icons in the right hand frame is selected, the contents of the left hand frame is replaced with generic printer device information as illustrated in FIG. 2. The information comprises:

Driver Name A friendly name for the selected device;

Documents The number of print jobs in the printer queue for the device;

Status The status of the port;

Model A non-friendly name for the device;

Waiting time The estimated time for a new document to be printed using the device.

In addition, the frame contains a hyperlink to a relevant Microsoft Internet support page. NB. It should be noted that earlier versions of the Windows™ operating system only use a subset of this information. For example Windows™ 95 OSR 2.1 and 98 only display the Driver Name and Documents information.

### STATEMENT OF THE INVENTION

The inventor of the present invention has recognised that the information which can be presented to a user via a web view style browser window is necessarily limited because it is defined by Microsoft and must therefore be generic to all other vendor software. The solution to this problem is to enable vendors and others to provide their own web views or data which can be incorporated into a browser window.

According to a first aspect of the present invention there is provided a computer system comprising processing means and a display, the processing means being arranged in use to implement a Microsoft Windows™ operating system under which a management window can be displayed on said display such that it can be navigated using a web browser, the management window having a first frame containing a web style page and a second frame displaying one or more systems which can be controlled by the user, wherein upon selection of one of the systems by the user the current page displayed in said first frame or a part thereof is replaced by a page specific to the selected system.

Preferably, the page specific to the selected system displays management information and options.

Preferably, the specific pages for each system are provided by the manufacturers of the systems and are installed into the computer system at the same time as the installation of the system.

For certain versions of Windows™, selection of one of the systems by the user causes the current page displayed in said first frame to be replaced by a page specific to the selected system. For other versions however, selection may cause only a part of the current page, displayed in said first frame, to be replaced or updated.

According to a second aspect of the present invention there is provided a method of displaying information on a computer, the computer operating under a Microsoft Windows™ operating system which facilitates the display of a management window such that the management window can be navigated using a web browser, and the management window having a first frame containing a web style page and a second frame displaying one or more systems which can be controlled by the user, the method comprising the steps of:

detecting the selection of one of said systems by a user; and

replacing the page currently displayed in said first frame or a part thereof with a page specific to the selected system.

According to a third aspect of the present invention there is provided a computer operating system comprising at least one html file specifying the structure and operation of a management window which can be displayed on a display of a computer such that the management window can be navigated using a web browser, the management window having a first frame containing a web style page and a second frame displaying one or more systems which can be controlled by a user, wherein upon selection of one of the systems by the user the current page displayed in said first frame or a part thereof is replaced by a page specific to the selected system.

The html file may contain code specifying each display page associated with a system. Alternatively, the html file may contain links to respective web pages which are followed upon selection of a system by a user.

According to a fourth aspect of the present invention there is provided a computer memory encoded with executable instructions representing a computer program for causing a computer to install a device driver and to modify an html file of the computer operating system, which html file specifies the structure and operation of a management window which can be displayed on a display of a computer such that the management window can be navigated using a web browser, the management window having a first frame containing a web style page and a second frame displaying one or more devices which can be controlled by a user, the modification causing the computer to react to selection of the installed device driver by replacing the current page displayed in said first frame or a part thereof by a page specific to the installed device.

Preferably, the modification to the html file comprises installing into the file a link to the device specific page, said computer program storing the page in a memory of the computer. Alternatively, the modification may comprise adding the web page to the html file.

By way of example, the present invention may be used to display a printer management window, with the systems/devices displayed in the second frame of the window being printer devices. The page which is displayed in the first frame when a device is selected is a page provided by the device manufacturer. Upon installation of the printer device driver, the printers.htt file of the Windows™ operating system is modified to contain a web page corresponding to the device or a link to such a page. Files specifying other Web view style management windows may be similarly modified upon installation of corresponding devices or systems.

In certain embodiments of the invention, the web page displayed in the first frame when a system/device is selected comprises a user selectable hyperlink. Selecting the hyperlink causes a system/device specific web page to be loaded into the second frame and, optionally, the first frame, replacing the existing content. The new page contains additional management information and/or options.

### BRIEF DESCRIPTION OF THE DRAWINGS

FIG. 1 shows a printer management window displayed under the Microsoft Windows™ 2000 operating system, with no printer device selected;

FIG. 2 shows the printer management window of FIG. 1 with a printer device selected;

FIG. 3 shows a modified printer management window with a printer device selected;

FIG. 4 illustrates an expanded Status Monitor window; and

FIG. 5 is a flow diagram illustrating a method of graphically displaying information.

### DETAILED DESCRIPTION OF A PREFERRED EMBODIMENT

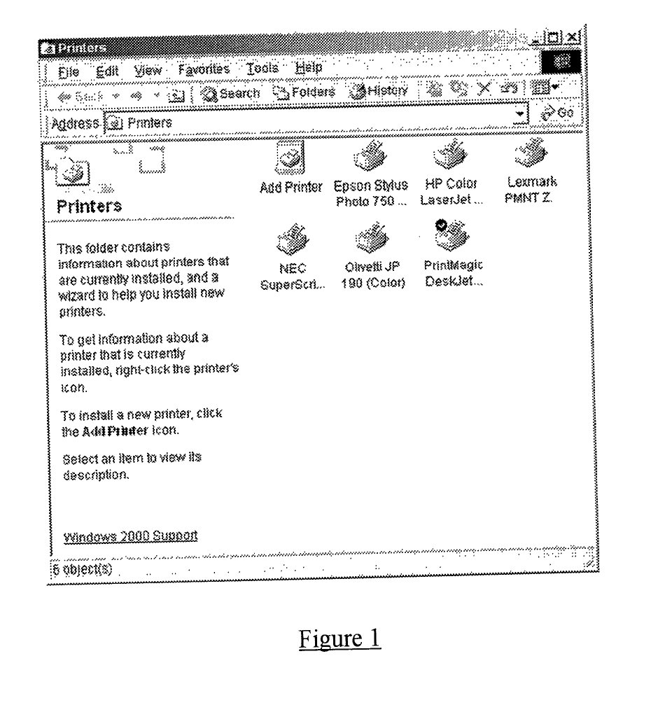

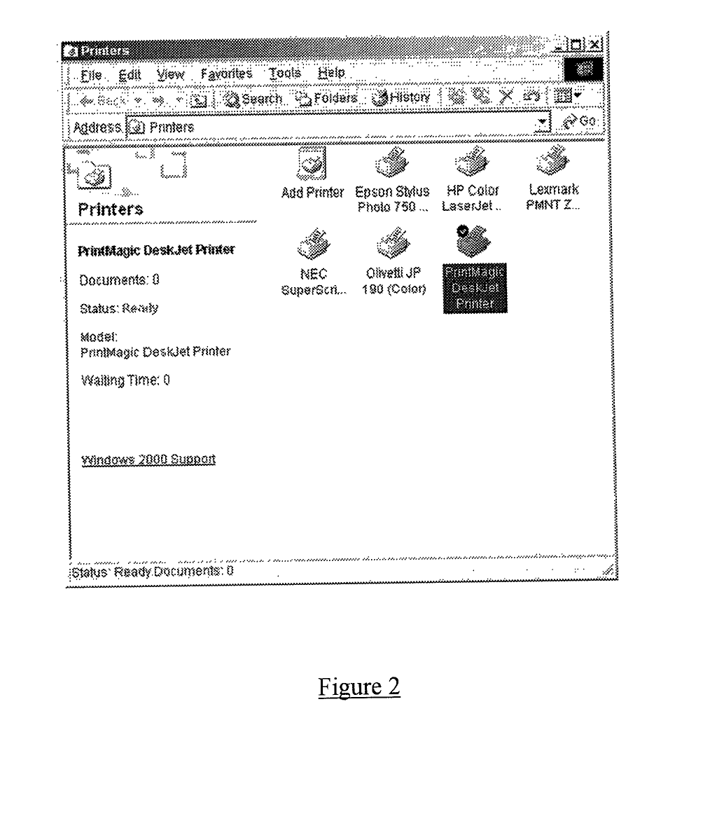

The web views provided by Microsoft Windows™ 95 OSR 2.1, 98, 2000, and Millennium, have been described above with reference to FIGS. 1 and 2. In order to enable vendors to provide device specific information in these web views, there is described below a modification to the Windows™ operating systems. Firstly however, considering the printer management window, the result achieved by this modification is described.

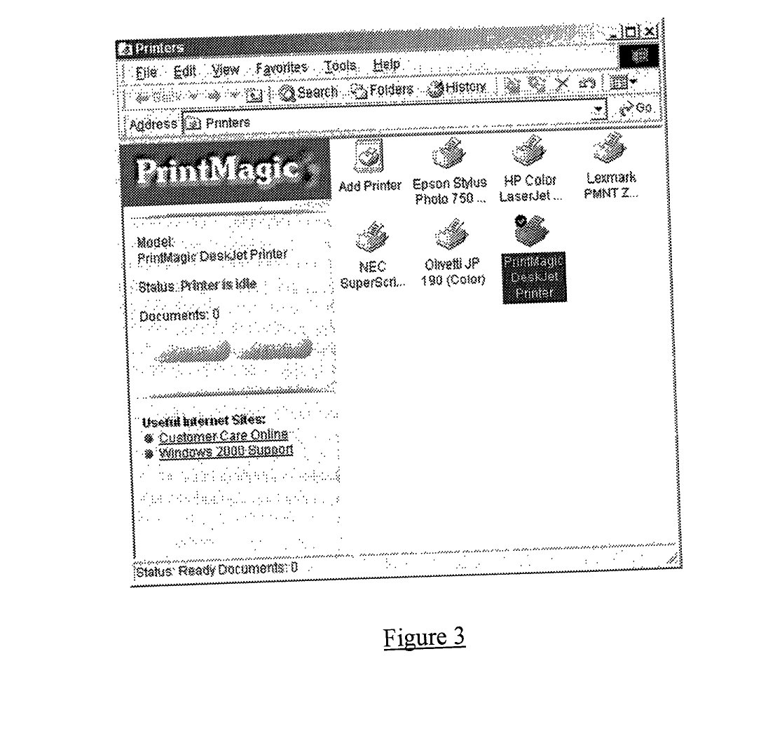

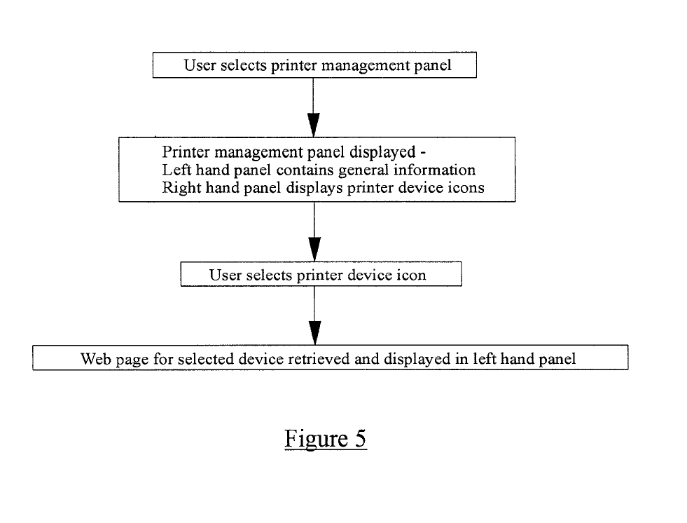

When a user selects the printer management window, the window style of FIG. 1 is presented. However, when the user selects a printer device by right clicking his mouse over the device, a web page is automatically loaded into the left hand frame to replace the current content (providing that upon installation of the device a suitable web page was provided to the operating system). The printer management window is illustrated in FIG. 3 with a typical device specific page loaded into the left hand frame. The method is further illustrated by the flow diagram of FIG. 5. In the event that no suitable page was provided by the operating system upon installation of the selected device, the Windows™ default page (as shown in FIG. 2) is loaded into the left hand frame.

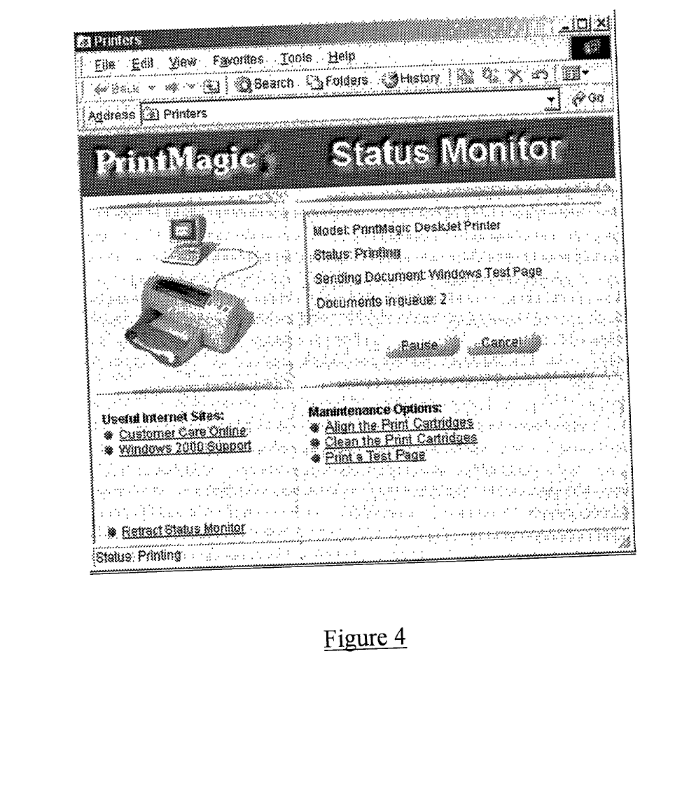

With reference to FIG. 3, the left hand frame provides the manufacturer of the selected device with an opportunity to display manufacturer specific information, including the manufacturer's logo, and options including print pause and cancel options. The frame also displays hyperlinks which a user can select to connect to an Internet support page of the device manufacturer and Microsoft. The frame may also provide an option (i.e. button) to expand the “status monitor” to fill the entire management window. With reference to FIG. 4, the status monitor may display information on the number and types of cartridges installed, the level of ink in the cartridges (cartridges installed and ink levels not shown), and give access to a variety of maintenance options that may include cleaning and aligning the print heads.

By controlling the web view in this way, printer driver vendors have the ability to completely change the appearance of the view, for example to reflect the style(s) used by other parts of the device software, on the packaging and supplied manuals or on the printer driver vendor's own web site. In addition, the modified web views allow vendors to add extra control functionality, in turn allowing for greater user interaction.

Windows™ 95 OSR 2.1, 98, 2000 and Millennium operating systems include a file printers.htt located in the c:\windows\web (or c:\winnt\web in the case of Windows 2000™) folder. This file is an html file and can be read by Microsoft Internet Explorer or other web browsers. It is proposed here that a new standard is defined which allows the printers.htt file to be modified upon installation of a new printer device. More particularly, the installation process adds a link into the file to a manufacturer specific web page. The web page itself is stored locally during installation in the c:\windows\web folder. The link is activated when the user selects the installed device. The standard will ensure that installation of multiple devices can be achieved without conflicts arising.

It will be appreciated by the person of skill in the art that various modifications may be made to the above described embodiments without departing from the scope of the present invention. For example, the principle of the invention may be applied to other Web view style management windows. One example is the Control Panel Folder. A software manufacturer may supply a CPL file to be installed into the Control Panel to configure a piece of hardware (e.g. a sound card or a DVD player). In the case, it is the controlp.htt which must be modified.

In certain (future) versions of Windows™, the left hand frame of a window may be split into a set of vertically expandable smaller frames, e.g. for the printers control window, one of these smaller frames may be called “Devices” and will contain the almost same generic information as the entire left hand frame in Windows 2000™. Therefore the present invention may be applied to override that frame with printer driver vendor specific information whilst leaving the other (smaller frames) unchanged.

1. A computer system comprising processing means and a display, the processing means being arranged in use to implement a Microsoft Windows™ operating system under which a management window can be displayed on said display such that it can be navigated using a web browser, the management window having a first frame containing a web style page and a second frame displaying one or more systems which can be controlled by the user, wherein upon selection of one of the systems by the user the current page displayed in said first frame or a part thereof is replaced by a page specific to the selected system.

2. A system according to claim 1, wherein the page specific to the selected system displays management information and options.

3. A system according to claim 1 or 2, wherein the specific pages for each system are provided by the manufacturers of the systems and are installed into the computer system at the same time as the installation of the respective systems.

4. A method of displaying information on a computer, the computer operating under a Microsoft Windows™ operating system which facilitates the display of a management window such that the management window can be navigated using a web browser, and the management window having a first frame containing a web style page and a second frame displaying one or more systems which can be controlled by the user, the method comprising the steps of:
detecting the selection of one of said systems by a user; and
replacing the page currently displayed in said first frame or a part thereof with a page specific to the selected system.

5. A method according to claim 4, wherein said management window is a printer management window, with the systems displayed in the second frame of the window being printer devices and wherein, upon installation of the printer device driver, the printers.htt file of the Windows™ operating system is modified to contain a web page corresponding to the device or a link to such a page.

6. A method according to claim 4 or 5, wherein the web page displayed in the first frame when a system is selected comprises a user selectable hyperlink and selection of the hyperlink causes a system specific web page to be loaded into the second frame and, optionally, the first frame, replacing the existing content.

7. A computer operating system comprising at least one html file specifying the structure and operation of a management window which can be displayed on a display of a computer such that the management window can be navigated using a web browser, the management window having a first frame containing a web style page and a second frame displaying one or more systems which can be controlled by a user, wherein upon selection of one of the systems by the user the current page displayed in said first frame or a part thereof is replaced by a page specific to the selected system.

8. A method according to claim 5 or a system according to claim 7, wherein the html file contains code specifying each display page associated with a system.

9. A method according to claim 5 or a system according to claim 7, wherein the html file may contain links to respective web pages which are followed upon selection of a system by a user.

10. A computer memory encoded with executable instructions representing a computer program for causing a computer to install a device driver and to modify an html file of the computer operating system, which html file specifies the structure and operation of a management window which can be displayed on a display of a computer such that the management window can be navigated using a web browser, the management window having a first frame containing a web style page and a second frame displaying one or more devices which can be controlled by a user, the modification causing the computer to react to selection of the installed device driver by replacing the current page displayed in said first frame or a part thereof by a page specific to the installed device.

11. A memory according to claim 10, wherein the modification to the html file comprises installing into the file a link to the device specific page, said computer program storing the page in a memory of the computer.

12. A memory according to claim 10, wherein the modification comprises adding the web page to the html file.
